(19) United States
(12) Patent Application Publication
(10) Pub. No.: US 2016/0119465 A1
(43) Pub. Date: Apr. 28, 2016

(54) SMART REMOTE CONTROL DEVICE FOR ELECTRIC LIFT TABLE

(71) Applicant: Kwok Keung Chan, Shenzhen City (CN)

(72) Inventor: Kwok Keung Chan, Shenzhen City (CN)

(21) Appl. No.: 14/664,949

(22) Filed: Mar. 23, 2015

(30) Foreign Application Priority Data
Oct. 27, 2014 (CN) 201420624777.0

(51) Int. Cl. H04M 1/725; G05B 15/02; H04W 4/00

(52) U.S. Cl. CPC H04M 1/72533; H04W 4/008; H04M 1/7253; G05B 15/02

(57) ABSTRACT

The invention provides a smart remote control device for electric lift table, which belongs to lift table technical field. The invention comprises a control power module, an actuation power module, at least one intelligent terminal with Bluetooth function, a Bluetooth module, a MCU unit, a motor driving module, at least one linear motor and at least one speed encoder. The control power module connects to the Bluetooth module, the MCU unit and the speed encoder module respectively. The actuation power module output connect to an input of the motor driving module, an output of the motor driving module connects to the linear motor. The speed encoder is connected with the linear motor. Said intelligent terminal with Bluetooth function is wirelessly connected to the Bluetooth module. Said MCU unit is respectively connected with the Bluetooth module, the motor driving module and the speed encoder. In present invention, the control unit of the intelligent terminal controls a movement of the linear motor by MCU unit, and controls a stable lift of the electric lift table by operation of the speed encoder.

### BACKGROUND

1. Field

The invention belongs to lift table technical field, in particular to a smart remote control device for electric lift table.

2. Description of Related Art

Traditional lift tables are controlled by using the control panel which connect to an electric control box via wires. By users manipulating buttons on the control panel, control message is sent to a MCU in a main circuit board, and output signal to an motor to actuate lift function of the lift table. The drawbacks of aforesaid application includes: wiring connection to the control panel is required whenever the lift table is controlled to lift, and any failing of the control panel due to accidents may cause the lift table out of control. Otherwise, control values relative to the lift function, such as speed of lift and time duration of indication lighting, are default set in the MCU, users are not allowed to change or adjust.

### SUMMARY

The objective of present invention is to overcome the drawbacks existing in the prior art. Present invention provides a smart remote control device for electric lift table. The invention achieves data transmission between the intelligent terminal and the MCU unit, and controls a stable lift of the electric lift table.

The objective of present invention is achieved by following technology program: a smart remote control device for electric lift table, comprises a control power module, an actuation power module, at least one intelligent terminal with Bluetooth function, a Bluetooth module, a MCU unit, an motor driving module, at least one linear motor and at least one speed encoder.

Said control power module connects to the Bluetooth module, the MCU unit and the speed encoder module, respectively. The control power module supply power to the Bluetooth module, the MCU unit and the speed encoder module. Said actuation power module output connect to an input of the motor driving module, an output of the motor driving module connect to the linear motor, the speed encoder connects to the linear motor. The intelligent terminal with

Bluetooth function is wirelessly connected to the Bluetooth module, and thus achieves a wireless data transmission. The MCU unit connects to the Bluetooth module, the motor driving module and the speed encoder, respectively.

Said intelligent terminal with Bluetooth function, preferably is an apparatus like mobile phone or tablet PC with Bluetooth function. The intelligent terminal comprises a control unit, the control unit controls a movement of the linear motor by the MCU unit.

The function of said motor driver is precise control of the rotational speed and of rotational direction, to stabilize the motor.

Said speed encoder preferably is a quadrature encoder, which comprises two Hall components separated by 90 degree angle and a permanent magnet. With rotation of the permanent magnet, the Hall components output speed quadrature signals. Normally, a speed encoder outputs a group of pulse, the dual output quadrature encoder output two groups of pulse A/B that phase's difference thereof is 90 degrees. By these two groups of pulse, it not only measures the rotational speed, but also the rotational direction.

Said MCU unit obtains and uses an output signal of the speed encoder, to synchronize the linear motor and calculate a position of the tappet.

Said control power module preferably is connected with 220V or 110V AC power source;

Said actuation power module preferably is connected with 220V or 110V AC power source;

The number of said linear motor and the corresponding speed encoder is not limit as only one, there can be more than one linear motor and corresponding speed encoder connected to each other.

The working process of the invention is:

The MCU unit controls the motor driving module to actuate the linear motor. The speed encoder detects an operational speed of the motor, and sends the value to the MCU unit. The MCU unit calculates the speed signal that sent by each speed encoder, and adjusts each linear motor to control a speed output, thereby provides a level auto-adjustment function, and controls a stable lift of the electric lift table. Users may implement the control function by using the intelligent terminal with Bluetooth module that exchanging data with the MCU unit.

Comparing with the prior art, the invention has advantage and effect as follow:

The invention allows the intelligent terminal with Bluetooth function wirelessly connect to the Bluetooth module, thus achieves a wireless data transmission. Such manner replaces the traditional way that lift table uses wire to connect and control the electric box, therefore avoids the lift table out of control because failing of the control panel due to accidents caused.

The intelligent terminal of the invention transmit data relative to lift function to MCU unit through the Bluetooth module, which overcome the drawback that users is not allowed to change data in MCU unit.

Furthermore, the MCU unit calculates the speed signal that sent by each speed encoder, and adjusts each linear motor to control a speed output, thereby provides a level auto-adjustment function, and controls a stable lift of the electric lift table.

### BRIEF DESCRIPTION OF THE DRAWINGS

FIG. 1 illustrates a block diagram representing an exampary embodiment of a smart remote control device for electric lift table according to present invention.

### DESCRIPTION OF EMBODIMENTS

Other features and advantages of the present invention will become apparent in the following detailed description of the preferred embodiment with reference to the accompanying drawings, of which:

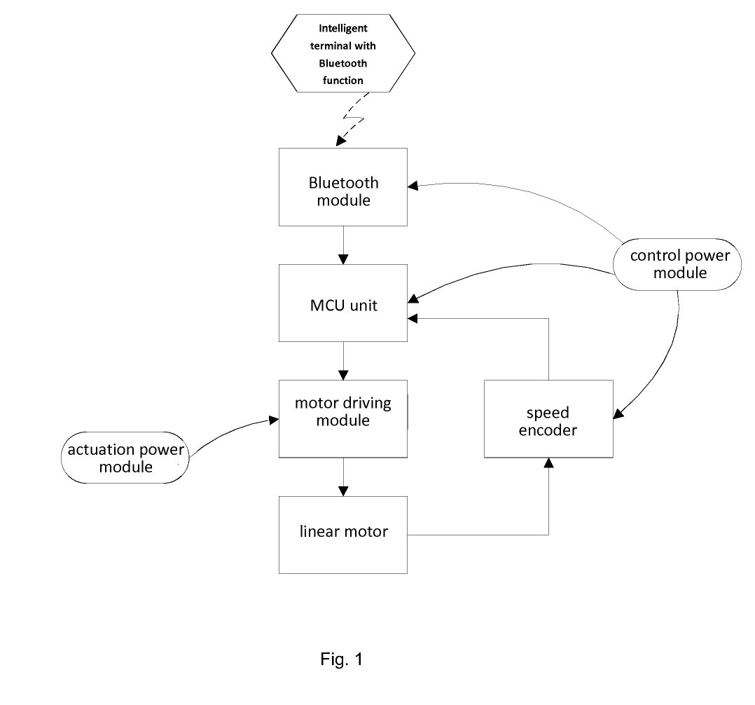

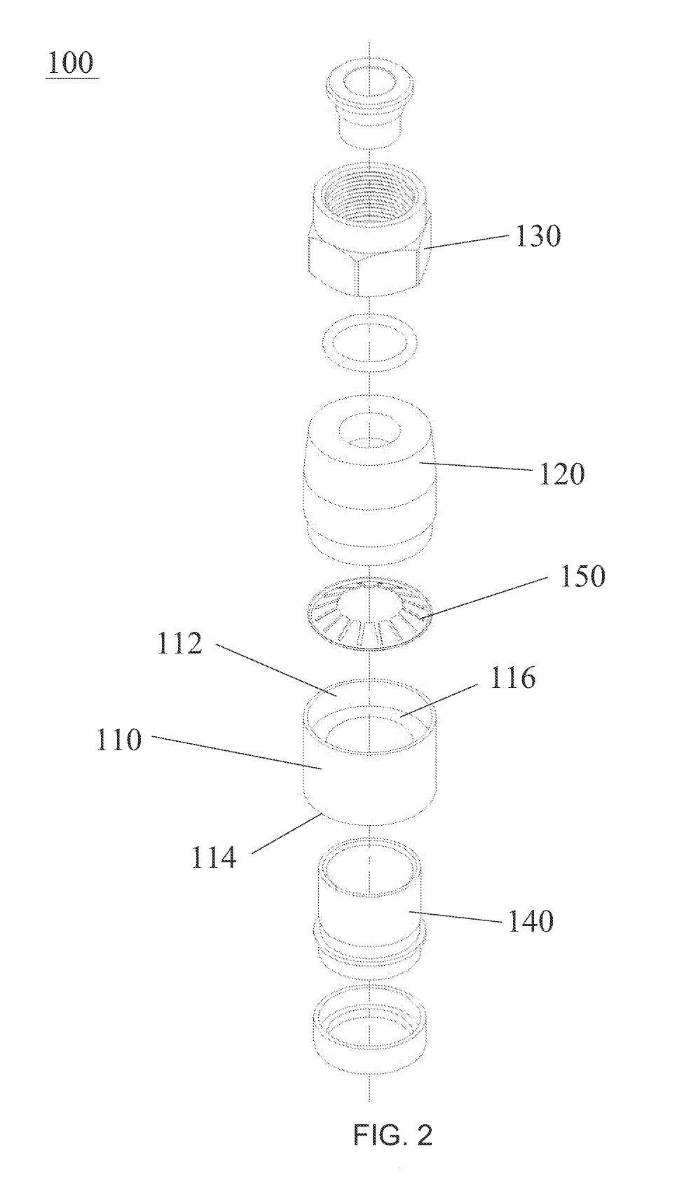

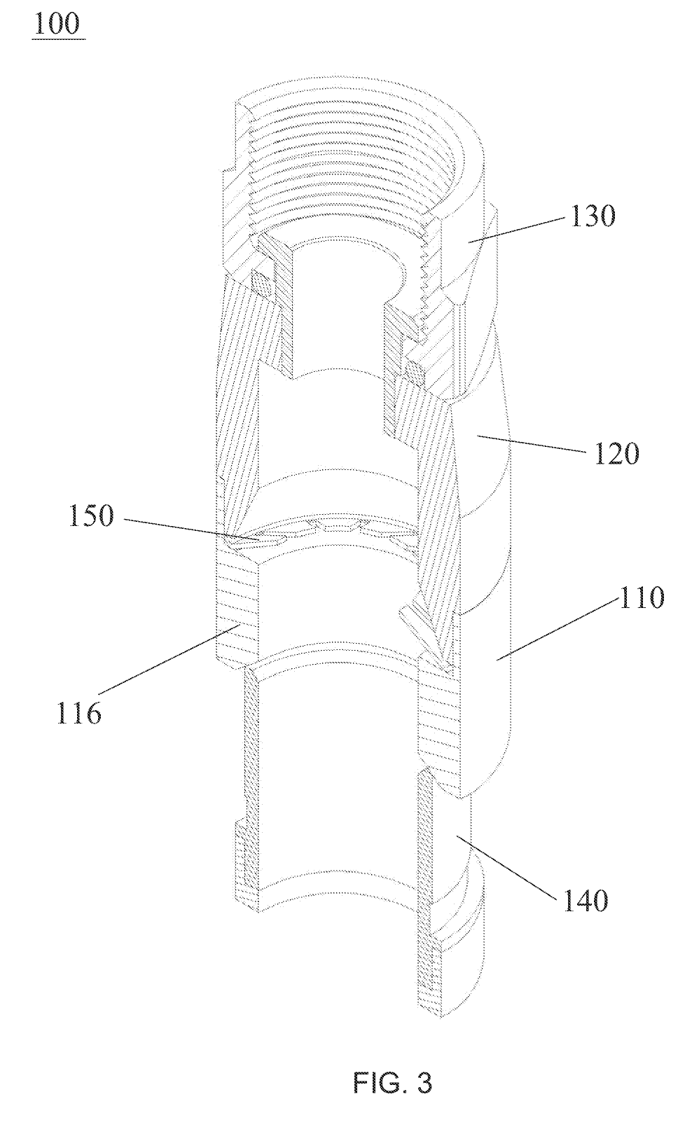

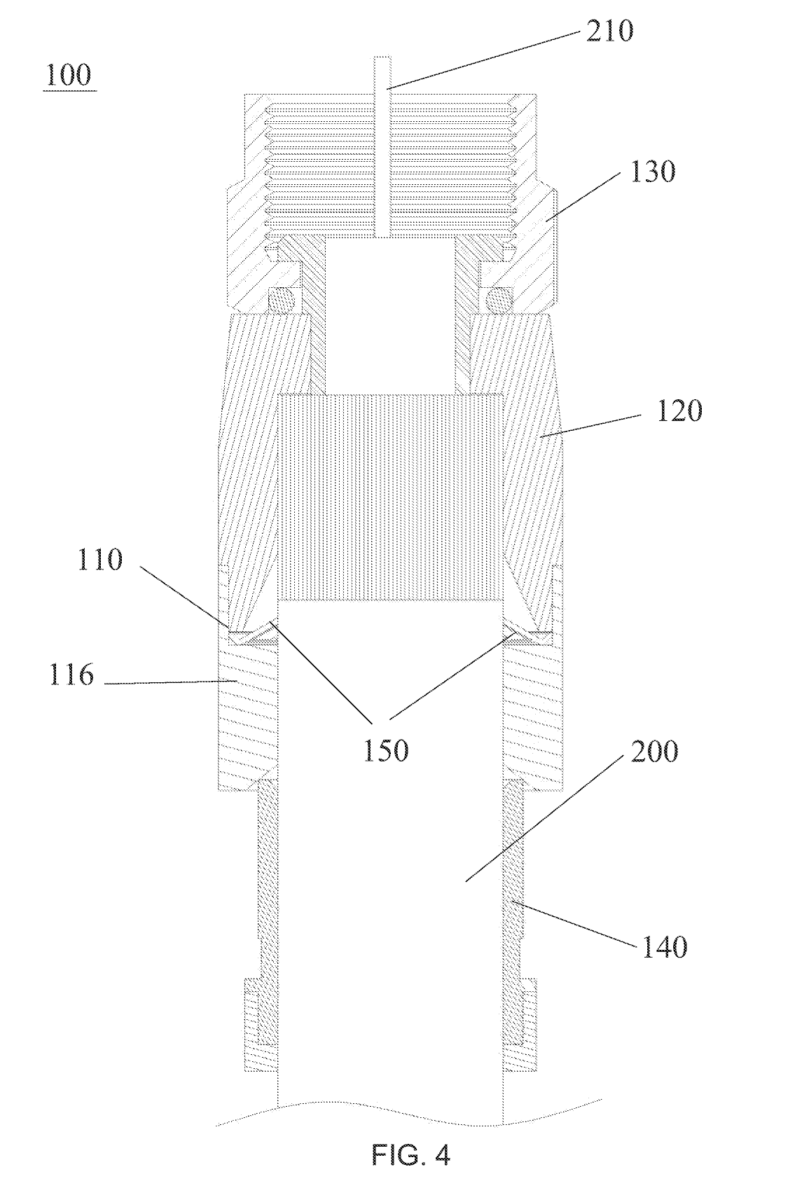

As shown in FIG. 1, the invention provides a smart remote control device for electric lift table, comprises a control power module, an actuation power module, at least one intelligent terminal with Bluetooth function, a Bluetooth module, a MCU unit, a motor driving module, at least one linear motor and at least one speed encoder.

The control power module is connected with the Bluetooth module, the MCU unit and the speed encoder module respectively. The control power module supply power to the Bluetooth module, the MCU unit and the speed encoder module. The actuation power module has an output connected to an input of the motor driving module. An output of the motor driving module is connected to the linear motor. The speed encoder connects to the linear motor. The intelligent terminal with Bluetooth function is wirelessly connected to the Bluetooth module and achieves a wireless data transmission. The MCU unit connects to the Bluetooth module, the motor driving module and the speed encoder respectively.

Notely, the intelligent terminal with Bluetooth function may be a mobile phone or tablet PC apparatus with Bluetooth function. The intelligent terminal has a control unit. The control unit controls a movement of the linear motor by the MCU unit.

The function of the motor driver is to precisely control the rotational speed and the rotational direction, so as to stabilize the motor.

Said speed encoder preferably is a quadrature encoder, which comprises two Hall components separated by 90 degree angle and a permanent magnet. With the rotation of the permanent magnet, the Hall components output a speed quadrature signals. Normally, a speed encoder outputs a group of pulse, the dual output quadrature encoder output two groups of pulse A/B that phase's difference thereof is 90 degrees. By these two groups of pulse, it not only measures the rotational speed, but also the rotational direction.

Said MCU unit obtains and uses the output signal of the speed encoder, to synchronize the linear motor and calculate a position of the tappet.

Said control power module is connected with 220V or 110V AC power source;

Said actuation power module is connected with 220V or 110V AC power source;

The number of the linear motor and the corresponding speed encoder is not limit in one, multiple linear motors and corresponding speed encoders are allowed.

With MCU unit controls the motor driving module to operate the linear motor, the speed encoder detects an operation speed of the motor, and sent it to the MCU unit. The MCU unit calculates the speed signal that sent by each speed encoder, and adjusts each linear motor to control a speed output, thereby provides a level auto-adjustment function, and controls a stable lift of the electric lift table. Users may implement the control function by using the intelligent terminal with Bluetooth module that exchanging data with the MCU unit.

The foregoing is illustrative of exemplary embodiments and is not to be construed as limiting thereof. Any other changes in the present invention is not departing from the spirit and principles made by the modification, alternatively, the combination of simplification, the replacement pattern should be equivalent, are included within the scope of the present invention.

What is claimed is:

1. A smart remote control device for electric lift table, comprises a control power module, an actuation power module, at least one intelligent terminal with Bluetooth function, a Bluetooth module, a MCU unit, a motor driving module, at least one linear motor and at least one speed encoder, wherein:
the control power module connects to the Bluetooth module, the MCU unit and the speed encoder module respectively;
the actuation power module has an output connected to an input of the motor driving module;
an output of the motor driving module connects to the linear motor;
the speed encoder connects to the linear motor;
the intelligent terminal with Bluetooth function is wirelessly connected to the Bluetooth module;
the MCU unit connects to the Bluetooth module, the motor driving module and the speed encoder.

2. The smart remote control device for electric lift table as claimed in claim 1, wherein the intelligent terminal with Bluetooth function is mobile phone or tablet PC apparatus with Bluetooth function, said intelligent terminal has a control unit controlling a movement of the linear motor by the MCU unit.

3. The smart remote control device for electric lift table as claimed in claim 1, wherein said speed encoder is a quadrature encoder comprising two Hall components separated by 90 degree angle and a permanent magnet.

4. The smart remote control device for electric lift table as claimed in claim 1, wherein the number of the linear motor and the corresponding speed encoder is one.

5. The smart remote control device for electric lift table as claimed in claim 1, wherein the number of the linear motor and the corresponding speed encoder is more than one.
